(19) United States
(12) Patent Application Publication
(10) Pub. No.: US 2009/0241026 A1
(43) Pub. Date: Sep. 24, 2009

(54) SYSTEMS AND METHODS FOR DISPLAYING ROLLING SEQUENCES

(76) Inventors: Nancy L. Augustine, Pleasant Hill, CA (US); John Carr, Antioch, CA (US); Ben Goldberg, Pleasanton, CA (US); Randall Jones, Carrollton, TX (US); Cheryl L. Paterson, Alameda, CA (US); Ev Shafrir, Mountain View, CA (US); Gregg Stratton, San Francisco, CA (US)

Correspondence Address: WILSON SONSINI GOODRICH & ROSATI, 650 PAGE MILL ROAD, PALO ALTO, CA, 94304-1050, US

(21) Appl. No.: 12/053,517

(22) Filed: Mar. 21, 2008

(51) Int. Cl. G06F 3/00

(52) U.S. Cl. 715/700

(57) ABSTRACT

Systems and methods for displaying rolling sequences, such as time periods or data status may include a user interface displaying multiple panes providing access to data relating to a given time category. If a time category were to pass, the access to data relating to a given time category may move to the position and format held by the prior time category. The invention may be applied to payroll processing or other human capital management software, which may provide means for displaying payroll information of employees for multiple time categories at once, and may enable payroll information to transition as time categories pass.

### FIELD OF THE INVENTION

This invention is directed to systems and methods of displaying rolling sequences, such as time periods or data status. The invention may be applied to payroll processing or human capital management software, which may provide means for displaying payroll or other human capital management information of employees for multiple time categories at once, and may enable such information to transition as time categories pass.

### BACKGROUND OF THE INVENTION

Every employer is faced with the regular generation of payroll for its employees. Initially, payroll processing was an arduous manual task, requiring the responsible individual to compute the base pay, applicable taxes, and other deductions for each of the employer's employees. Initially, these calculations were performed by hand. Over time, automated systems have been developed to calculate pay, produce payroll checks, and even to make the automatic payroll deposits into an employee's bank account for employees participating in a direct deposit program. Automated systems have also been developed to deal with overall human capital management.

Prior payroll automation and human capital management systems generally provide an employer with the ability to analyze the payroll or other human capital management in a myriad of respects appropriate to identifying appropriate events. Such automation systems also permitted a means of comparison of information, such as payroll information for a current pay period to payroll information for an earlier pay period. However, such automation systems failed to provide a user display of payroll or other human capital management information from multiple time periods at once that may transition as time periods pass in a straightforward manner, or to provide a display of payroll information of multiple statuses at once that may progress from one status to another. Such payroll systems fail to visually incorporate the concept of time and progress.

There is a need for improved systems and methods for displaying rolling time periods or data status, especially for data including payroll or human capital management data, in a visual manner that can better display transitions, progress toward goals, and the passage of time.

### SUMMARY OF THE INVENTION

The invention provides systems and methods for displaying rolling data sequences, such as time periods or data status. Various aspects of the invention described herein may be applied to any of the particular applications set forth below or for any other types of user interfaces and displays. The invention may be applied as a standalone system or method, or as part of an integrated software package, such as for payroll software. It shall be understood that different aspects of the invention can be appreciated individually, collectively, or in combination with each other.

One aspect of the invention provides for a user interface displayed on a display. For example, the implementation of software may include a client computer comprising a video display, with at least one display page comprising data. The data may include payroll software data.

The user interface may include panes providing access to data relating to given time categories. A pane may include a region of the user interface display. A pane may provide access to data in one or more different manners. Providing access to data may include any activity that may lead to creating using, modifying, or viewing the data. The panes do not need to provide access to data in the same manner or format.

The data may include any data that relates to a time category. In a preferable embodiment of the invention, the data may include human capital management data, which may include data such as payroll data (including items such as wage compensation and benefits), workforce planning, recruitment, induction/orientation, skills management, training and development, personnel administration, time management, travel management, personnel cost planning, or performance appraisal. A time category may include any data sequence, which may include a given period of time or may relate to data status. A given period of time may relate to any length of time, whether the length of time may relate to calendar units of time, smaller measurement units of time, or event-driven units of time. In a preferable embodiment of the invention, a given period of time may be a pay period. Data status may relate to the status of data, which may or may not be related to the passage of time. Data status may have a sequence, as periods of time may have a sequence. An earliest time category, where the time category may relate to data status, may include data status that is farthest along in a sequence and vice versa, since data from an earlier time may be further along in a status sequence.

In a preferable embodiment of the invention, the user interface may include a current pane providing access to data relating to a current time category. The user interface may also include a completed pane providing access to data relating to the time category immediately preceding the current time category, and positioned adjacent to the current pane. The user interface may also include a future pane providing access to data relating to the time category immediately following the current time category, and positioned adjacent to the current pane and opposite the completed pane. In one embodiment, the completed pane may be positioned to the right of the current pane, and the future pane may be positioned to the left of the current pane. In a preferable implementation of the invention, the current pane may provide access to open payroll data, the completed pane may provide access to submitted payroll data, and the future pane may provide access to unopened payroll data.

In another embodiment, the completed pane may be positioned anywhere adjacent to the current pane and the future pane may be positioned anywhere adjacent to the current pane and opposite the completed pane. The panes may be in a linear arrangement, which could have any orientation. For example, the future pane could be above the current pane, which could be above the completed pane. In an alternative embodiment, both the completed pane and the future pane may be positioned adjacent to the current pane but do not need to be opposite one another. For example, the future pane could be above the current pane, which could be to the left of the completed pane.

In another embodiment of the invention, there may be any number of panes wherein at least one pane provides access to data relating a current time category. The panes may be arranged so that each pane provides access to data relating to a given time category immediately prior to an adjacent pane and immediately subsequent to the other adjacent pane. In one embodiment, the panes may be lined up in a row with any orientation. A preferable orientation may have the pane providing access to data relating to the earliest time category on the right, and to have the pane providing access to data relating to the latest time category on the left. In another embodiment, the panes may be adjacent to one another but do not have to be in a straight line. For example, the panes could follow any sort of pattern, including a snaking pattern, as long as the time categories they relate to are in a sequential order.

One aspect of the invention provides for the shift in data access that may occur when a time category passes. The passing of a time category may include a progression in a sequence, such as a time period elapsing, a pay period passing, the change of data status, or any other event occurring. If a time category does pass, data access relating to a given time category may be moved to the position and format held by the prior time category. For example, if a pay period has elapsed, such as September and it is now currently October, the data access for September may go into the position previously held by August. A current pane may now provide access to data for October, and the data access for all other panes will be shifted accordingly.

In an alternate embodiment of the invention, the data accessing relating to a given time category may be moved to the position but not to the format held by the former time category.

By providing a shift in data access with the passage of a time category, the user interface may provide a visually intuitive means to display the concept of the passage of time and progress. In one embodiment of the invention where earlier time categories are positioned to the right, and later time categories are positioned to the left, one advantage of the invention is that it may show a sequence of data, whether it be through time or status, passing off to the right in a manner that is recognizable and familiar.

In accordance with another aspect of the invention, there may be multiple panes relating to a given time category. For instance, if the data related to human capital management data such as payroll data, and the time category was for submitted payroll data, the user interface may show a completed pane showing the providing access to submitted payroll data for the last monthly payroll, and another pane showing access to submitted payroll data for the last weekly payroll. Multiple panes relating to the same time category may be adjacent to one another.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the invention will be obtained by reference to the following detailed description that sets forth illustrative embodiments, in which the principles of the invention are utilized, and the accompanying drawings of which:

FIG. 1 shows a system with client computers interacting with a server over a network.

FIG. 2 shows a user interface including a future pane, a current pane, and a completed pane.

FIG. 3 shows an embodiment of a user interface with a future pane, a current pane, and a completed pane.

FIG. 4 shows a plurality of panes which may provide access to data relating to a given time category.

FIG. 5 illustrates how access to data relating to a given time category may roll as a time category may pass.

FIG. 6 shows a user interface with multiple panes relating to a given time category.

FIG. 7 shows another example of a user interface with multiple panes relating to a given time category.

FIG. 8 shows an embodiment of a user interface including a pane to add a worksheet to an open payroll.

### DETAILED DESCRIPTION OF THE INVENTION

While preferred embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

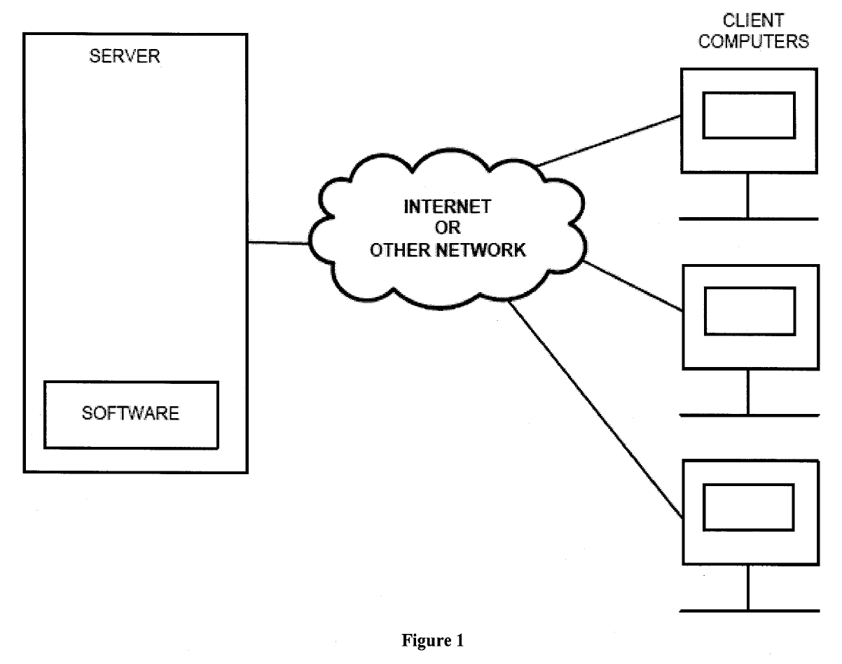

A user interface provided in accordance with the invention herein may be displayed across a network such as the Internet. For example, as shown in FIG. 1, an implementation of may include a client computer comprising a video display with at least one display page comprising data. The data may include human capital management data, which may include data such as payroll data (including items such as wage compensation and benefits), workforce planning, recruitment, induction/orientation, skills management, training and development, personnel administration, time management, travel management, personnel cost planning, or performance appraisal. Human capital management data may include data that can be person and time dependent. Human capital management may be heterogeneous across different businesses and a human capital management outsourcing software may advantageously display human capital management data.

Video displays may include devices upon which information may be displayed in a manner perceptible to a user, such as, for example, a computer monitor, cathode ray tube, liquid crystal display, light emitting diode display, touchpad or touchscreen display, and/or other means known in the art for emitting a visually perceptible output. Video displays may be electronically connected to a client computer according to hardware and software known in the art.

In one implementation of the invention, a display page may include a computer file residing in memory which is transmitted from a server over a network to a client computer, which can store it in memory. Similarly, one or more servers may communicate with one or more client computers across a network, and may transmit computer files residing in memory. The network, for example, can include the Internet or any network for connecting one or more clients to one or more servers.

At a client computer, the display page may be interpreted by software residing on a memory of the client computer, causing the computer file to be displayed on a video display in a manner perceivable by a user. The display pages described herein may be created using a software language known in the art such as, for example, the hypertext mark up language (“HTML”), the dynamic hypertext mark up language (“DHTML”), the extensible hypertext mark up language (“XHTML”), the extensible mark up language (“XML”), or another software language that may be used to create a computer file displayable on a video display in a manner perceivable by a user. Where network comprises the Internet, a display page may comprise a webpage of a type known in the art.

A display page according to the invention may include embedded functions comprising software programs stored on a memory, such as, for example, VBScript routines, JScript routines, JavaScript routines, Java applets, ActiveX components, ASP.NET, AJAX, Flash applets, Silverlight applets, or AIR routines.

A display page may comprise well known features of graphical user interface technology, such as, for example, frames, windows, scroll bars, buttons, icons, and hyperlinks, and well known features such as a “point and click” interface. Pointing to and clicking on a graphical user interface button, icon, or hyperlink also is known as “selecting” the button or hyperlink. A display page according to the invention also may incorporate multimedia features.

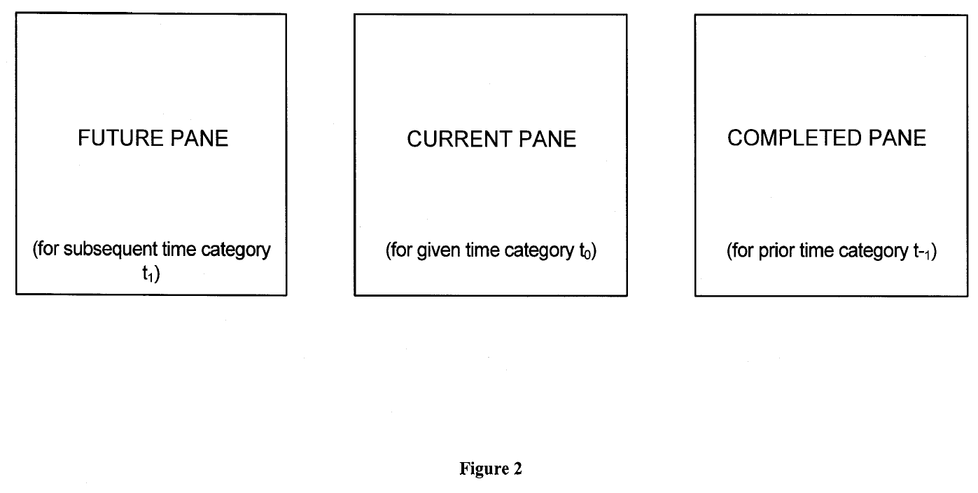

Referring to the drawings in detail, FIG. 2 shows a user interface provided in accordance with the invention that may include a future pane, a current pane, and a completed pane. The user interface may include panes providing access to data relating to given time categories. A pane may include a region of the user interface display. For example, a pane may have a defined geometric shape, such as a rectangle. In another example, a pane may have any defined shape, even if it irregular. A shape may be defined by some sort of visual cue, such as a border or color change. Alternatively, the pane itself may not have a defined shape, but may include a region which may provide access to data relating to a time category.

A pane may provide access to data in one or more different manners. Providing access to data may include any activity that may lead to creating, using, modifying, or viewing the data. For example, a pane may provide visual access to data by displaying the data within the pane. A pane may also provide access to data by providing a link or button or any other option that may enable a user to see the data in another view. Providing access to data may also include allowing a user to perform a function with the data, such as creating a new data object, editing existing data, or printing an item using the data. The panes do not need to provide access to data in the same manner or format.

The data may include any data that may relate to a time category. A time category may include any data sequence, which may include a given period of time or may relate to data status. Both periods of time and data statuses may have a sequence. An earliest time category, where the time category may relate to a period of time, may include a time period that is earliest in time. An earliest time category, where the time category may relate to data status, may include data status that is farthest along in a sequence and vice versa, since data from an earlier time may be further along in a status sequence. So for example, a time category for submitted payroll data may be considered earlier than a time category for open payroll data even if submitted payroll data is further along in a sequence because submitted payroll data relates to data from an earlier time. Similarly, submitted payroll data may also be considered to precede or be prior to open payroll data.

A given period of time may relate to any length of time, whether they relate to calendar units of time, smaller measurement units of time, or event-driven units of time. In a preferable embodiment of the invention, a given period of time may be a pay period. A pay period in the payroll processing art may be the intervals that employees are paid at, and may usually be chosen by an employer. Commonly, employees may be paid weekly, biweekly, semimonthly, or monthly, although other pay periods are possible. The period of time may be adaptable for any pay period desired by an employer. For example, a period of time could change from a month to a week if an employer were to change monthly pay periods to weekly pay periods.

In an alternate embodiment, the given period of time may be based on calendar units such as years, months, weeks, days. In another embodiment, the periods of times may be for smaller measurement units of time, such as hours, minutes, seconds, or portions thereof. In other embodiments, periods of time may vary in length and may be an event-driven unit of time, or may occur when an administrator of a system may decide to change the time period, and so forth.

Data status may relate to the status of data, which may or may not be related to the passage of time. Data status may have a sequence or progression so that data starts out with a particular status, then progresses to another status, and so forth. For example, payroll data may start as unopened payroll data, then become opened payroll data, then become submitted payroll data. Data status may be related to time if status sequence may be related to time. For instance, payroll data may start as unopened payroll data, and after some time may become opened payroll data, and after some additional time may become submitted payroll data. As discussed previously, an earliest time category, where the time category may relate to data status, may include data status that is farthest along in a sequence and vice versa, since data from an earlier time may be further along in a status sequence.

In a preferable embodiment of the invention, the data may include payroll data. Such payroll data may include data pertaining to employees, associated partners, or other pertinent parties. Payroll data may related to information such as payroll liability and payroll progress, such as worksheets for various employee groups, information on already submitted payroll, whether processing is complete, whether direct deposits or checks were sent, and so forth.

In a preferable embodiment of the invention, the user interface may include a current pane providing access to data relating to a current time category. The user interface may also include a completed pane providing access to data relating to the time category immediately preceding the current time category, and positioned adjacent to the current pane. The user interface may also include a future pane providing access to data relating to the time category immediately following the current time category, and positioned adjacent to the current pane. The user interface may enable a user to view panes providing access to data relating to multiple periods of time at once. In a preferable implementation of the invention, the current pane may provide access to open payroll data, the completed pane may provide access to submitted payroll data, and the future pane may provide access to unopened payroll data.

For example, if a user were viewing a user interface in August, the current time category may be open payroll data for where payroll data status may change monthly, and the current pane may provide access to data for August. The completed pane may provide access to submitted payroll data for July, and the future pane may provide access to unopened data for September. A user may be able to see multiple panes at once for July, August, and September. In an embodiment where the time category is a time period, the invention may display a rolling three month or other selected window time frame.

The passing of a time category may include a progression in a sequence, such as a time period elapsing, a pay period passing, the change of data status, or any other event occurring. As a time category were to pass, if the current time or data status were no longer within the time category held by the former current pane, the current pane may provide access to data relating to the new time category, and the future and completed panes may be adjusted accordingly. In other words, the current pane may provide access to data relating to the current time category, where the current time category may change as a sequence were to progress, through events such as the passage of time or change in data status.

If a time category were to pass, data access relating to a given time category may be moved to the position and format held by the prior time category. For example, if a pay period has elapsed, such as August and it is now currently September, the data access for August may go into the position previously held by July. A current pane may now provide access to data for July, and the data access for all other panes will be shifted accordingly.

In a preferable embodiment, the completed pane may be positioned to the right of the current pane, and the future pane may be positioned to the left of the current pane. For example, going from left to right, the panes may provide access to data for September, August, and July so that the data for earlier time categories may be accessed by panes further to the right.

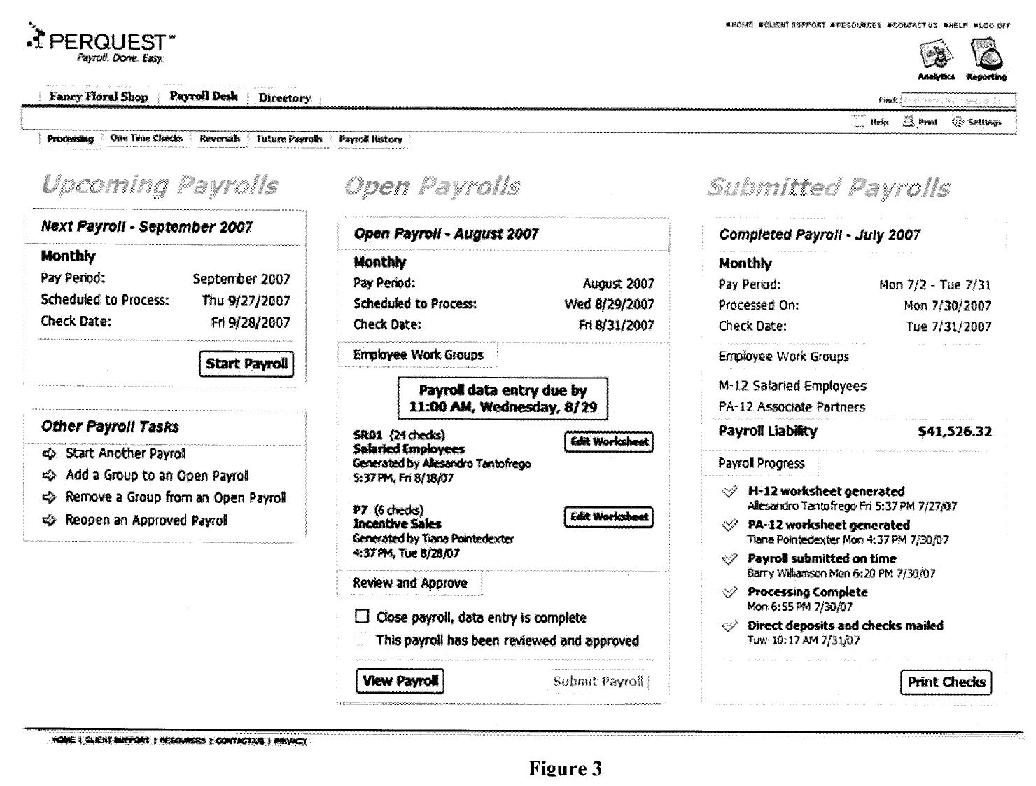

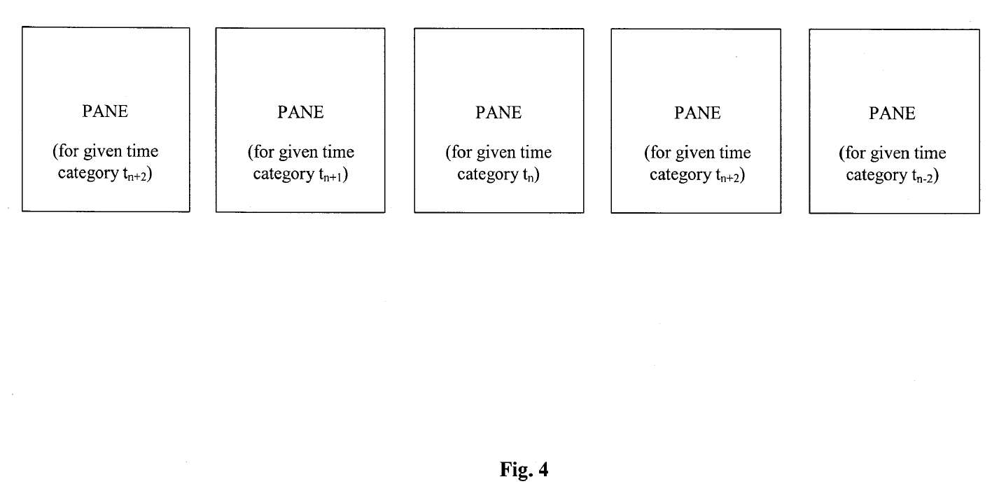

FIG. 3 illustrates a preferable embodiment of the invention where data may be payroll data, and a current pane may provide access to a current time category of open payroll data, which in this case may be for August. A completed pane located to the right of the current pane may provide access to a prior time category of submitted payroll data, which in this case may be for July, and a future pane located to the left of the current pane may provide access to a subsequent time category of unopened payroll data, which in this case may be for September. If a time category were to pass, the access to data may move to the right. For example, the access to data relating to a former current time category could move to the right, where the access to data relating to completed time category may be positioned. In other words, the data access for August may move to the right, which used to be occupied by the data access for July, and the data access for September may also move to the right, which used to be occupied by the data access for August.

In alternate embodiment of the invention, the future pane providing access to data relating to the time category immediately subsequent to the current time category may be positioned adjacent to the current pane and opposite the completed pane. This may include a number of orientations, such as if the pane for September was placed above the pane for August, which was placed above the pane for July, or any other orientation where the panes for September and July are both adjacent to August, but on opposite sides.

In yet another embodiment of the invention, the future pane and the current panes may be adjacent to the current pane, and do not have to be opposite one another. For example, if the current time category is August, the panes for September and July may be adjacent to the pane for August in any orientation. For example, the pane for September may be above the pane for August, while the pane for July may be to the right of the pane for August. In another example, the pane for September may be diagonally adjacent to August from the lower left, while the pane for July may be above the pane for August.

FIG. 3 also shows various tabs within the user interface. There may be major tabs which in one embodiment of the invention may refer to information about a business, payroll data for the business, and a directory of employees within the business. There may also be smaller tabs referring to specific aspects of the information provided by the major tabs. For instance, under the payroll tab, there may be smaller tabs for processing, one time checks, reversals, future payrolls, and payroll history. Smaller tabs may also include tabs for payroll progress, calendar, history, manual checks, autopost, templates, or any other content. The tabs may assist with navigating to and from different pages within the user interface.

FIG. 4 shows a plurality of panes which may provide access to data relating to a given time category. In one embodiment of the invention, there may be any number of panes. The panes may be arranged so that each pane may provide access to data relating to a given time category immediately prior to an adjacent pane and immediately subsequent to the other adjacent pane. For example, if there are five panes, if a pane at one end is for a given time category tₙ, the adjacent pane is for the immediately subsequent time category tₙ₊₁, and the other pane adjacent to that pane is for the next subsequent time category tₙ₊₂, and so forth. For example, if the given time categories were for months, then the five panes may be set up so that a pane for January may be adjacent to the pane for February, which may be adjacent to the pane for March, which may be adjacent to the pane for April, which may be adjacent to the pane for May.

In one embodiment of the invention, at least one of the plurality of panes may provide access to data relating to a current time category. For instance, if the current time category were the month of August, and there were five panes, at least one of those panes would provide access to data for August. For instance, there may be a current pane for August, a future pane for September, and three completed panes for May, June, and July, which may be arranged so that the pane for September may be adjacent to the pane for August, which may be adjacent to the pane for July, which may be adjacent to the pane for June, which may be adjacent to the pane for May.

In one embodiment, the panes may be lined up in a row with any orientation. For instance, the pane with the earliest time category could be at one end of the row while the pane for the latest time category could be at the other end of the row. The row may be oriented horizontally, vertically, diagonally, or at any angle.

A preferable embodiment of the invention may provide for an orientation where the pane providing access to data relating to the earliest time category on the right, and to have the pane providing access to data relating to the latest time category on the left. For instance, if there were five panes and the time categories were for months, going from left to right, the panes may provide access to data for September, August, July, June, and May.

In another embodiment, the panes may be adjacent to one another but do not have to be arranged in a straight line. For example, the panes could follow any sort of pattern, including a snaking pattern, as long as the time categories they relate to are adjacent to one another in a sequential order. For instance, if there were four panes and the time category was for years, a pane for 2007 could be above a pane for 2006, which may be to the left of a pane for 2005, which may be above a pane for 2004.

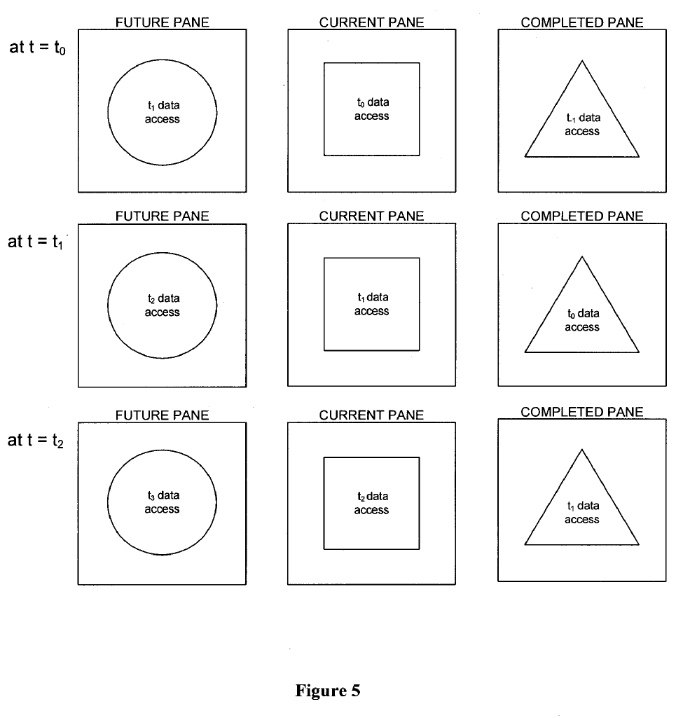

FIG. 5 illustrates how access to data relating to a given time category may roll as time passes or data status may change. One aspect of the invention provides for the shift in data access, which may occur when a time category passes. If a time category were to pass, such as a pay period passing, data access relating to a given time category may be moved to the position and format held by the prior time category. For example, if a pay period were monthly, and the pay period for September has elapsed so it is now currently October, the data access for September may go into the position previously held by August. The current pane, will now provide access to data for October, and the data access for all other panes will be shifted accordingly.

For instance, if the user interface had three panes, which were one future pane, one current pane, and one completed pane and an initial time category was the month of September, at the initial time, the future pane could provide access to data relating to October, the current pane could provide access to data relating to September, and the completed pane could provide access to data relating to August. If a time period were to pass so that the current time were October, then the future pane could provide access to data relating to November, the current pane could provide access to data relating to October, and the completed pane could provide access to data relating to September. Similarly, if an additional time period were to pass so that the current time became November, then the future pane could provide access to data relating to December, the current pane could provide access to data relating to November, and the completed pane could provide access to data relating to October.

As two time categories may pass, the access to data for a given time period may start at a future pane, then go to a current pane as a time category elapses, and then go to a completed pane as another time category elapses. In the previous example, the access to data relating to October started off in the position held by the future pane, then moved to the position held by the current pane, and then moved to the position held by the completed pane.

Similarly, in another example, the current pane may provide access to open payroll data, the completed pane may provide access to submitted payroll data, and the future pane may provide access to unopened payroll data. If payroll data were submitted and opened on a monthly basis, the access to data relating to a particular month may start off as unopened payroll data in the future pane, then progress to open payroll data in the current pane once it is opened, and then progress to submitted payroll data in the completed pane once it is submitted.

In one embodiment of the invention, data access relating to a given time category may be moved to the position and format held by the prior time category. For instance, different formats may or may not be held by different panes. A future pane may have a particular way of presenting access to data, which may or may not be different from the way that a current pane or a completed pane can provide access to data.

In one implementation where the data may be related to payroll data, the format for a future pane may include providing access to data relating to a future time category, such as unopened payroll data, by including an option that may lead to creating new payroll data, such as a link or button to start a new payroll. The format for a current pane may include providing access to data relating to a current time category, such as open payroll data, by including an option that may lead to modifying existing payroll data for one or more employee work groups, or by including an option which may display payroll data. The format for a completed pane may include providing access to data relating to a completed time category, such as submitted payroll data, by including an option that may visually provide access to payroll data and provide a checklist showing payroll progress.

As time categories may pass, the format for a particular pane may remain the same. For example, if an initial current time category is the month of September, and the time elapses to October, the pane formerly providing access to data relating to September may provide access to data relating to October in the same format as it had when it related to September. Also, the pane providing access to data relating to September may provide access to September's data in the same format as it had when it formerly related to August.

In an alternate embodiment of the invention, the data access relating to a given time category may be moved to the position held by the former time category, but not to the format. In some implementations, this may be the case when particular formats may be associated with a particular time category. For example, if an initial current time category the month of September, and the time elapses to October, the pane formerly providing access to data relating to September may provide access to data relating to October in the format that the prior pane for October had, which may or may not be different from the format the pane had when it provided access to data relating to September. Also, the pane providing access to data relating to September may provide access to September's data in the same format as September's former pane had, which may or may not be different from the format the pane had when it provided access to data relating to August.

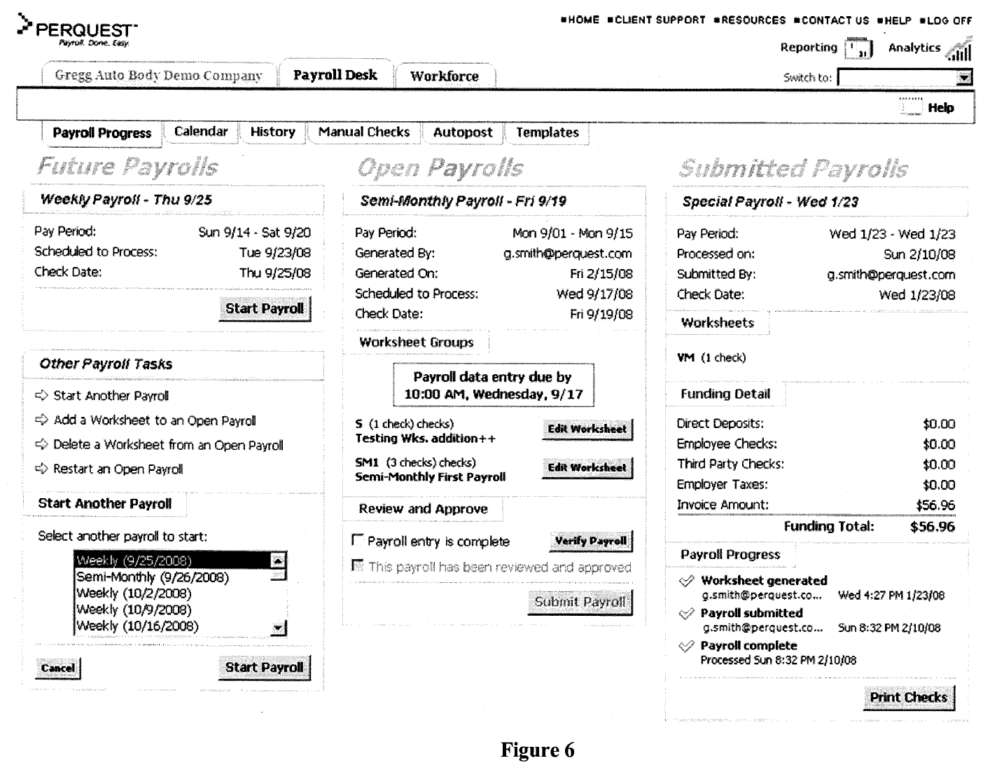

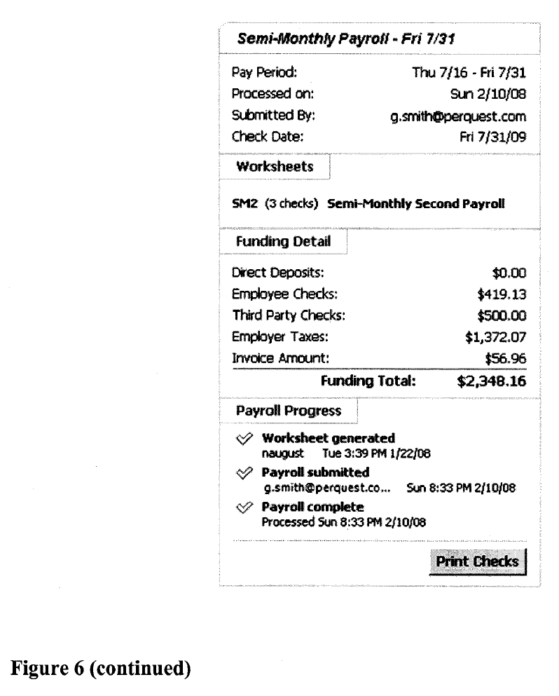

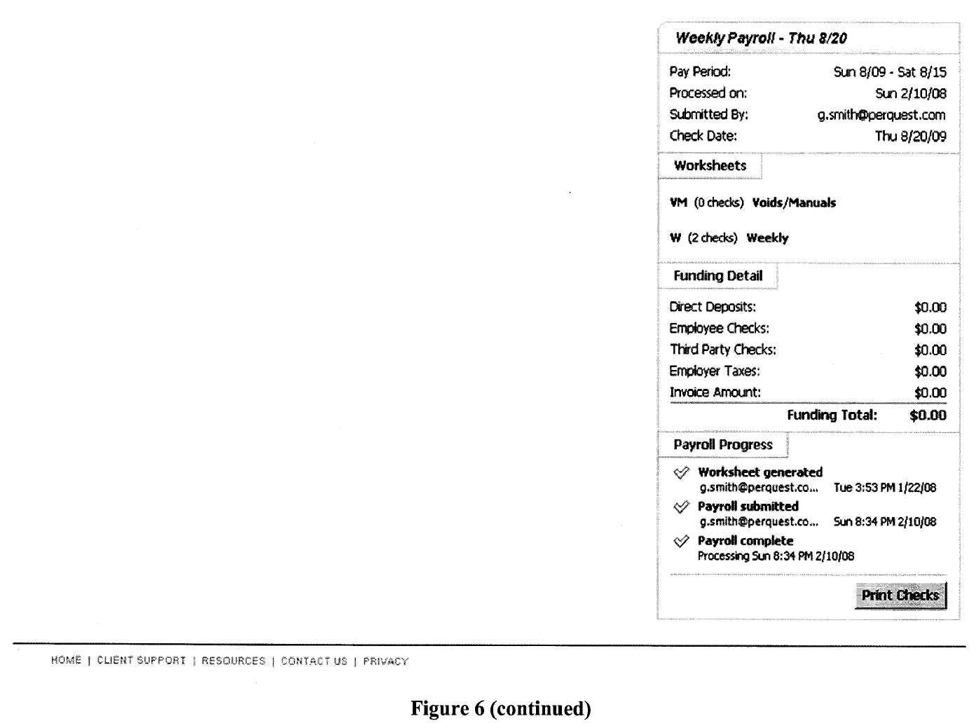

In accordance with another aspect of the invention, FIG. 6 shows a user interface with multiple panes relating to a given time category. As discussed previously a time category may relate to a data sequence, such as a time period or data status. A time category may include any way to divide time, so that one example of time categories may include whether the time is current, completed, or in the future. Another example of time categories may include whether data has been submitted, whether it is still open, or whether it has yet to be opened. Any time category may or may not include multiple panes.

In one implementation, if the data related to payroll data, and the time categories were for submitted, opened, and unopened payroll data, there may be multiple panes in any of the categories. For example, panes may be providing access to payroll data where there could be multiple employee groups which may get paid under different pay periods. One employee group may get paid semi-monthly, while another employee group may get paid weekly. In this case, there may be multiple panes for already submitted payroll data. For instance, there may be a pane for the last submitted semi-monthly payroll data, and there may be a pane for the last submitted weekly payroll data. In one example, there may be a special payroll, such as a bonus, in which case, a pane for the special payroll data may also appear as a submitted payroll data for a period of time.

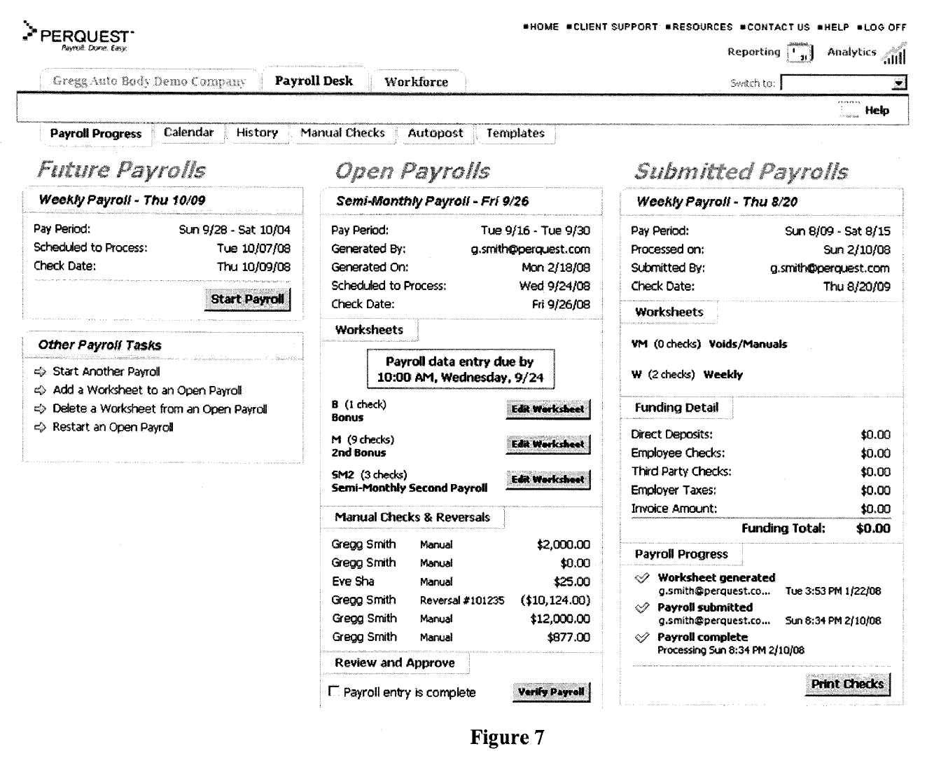

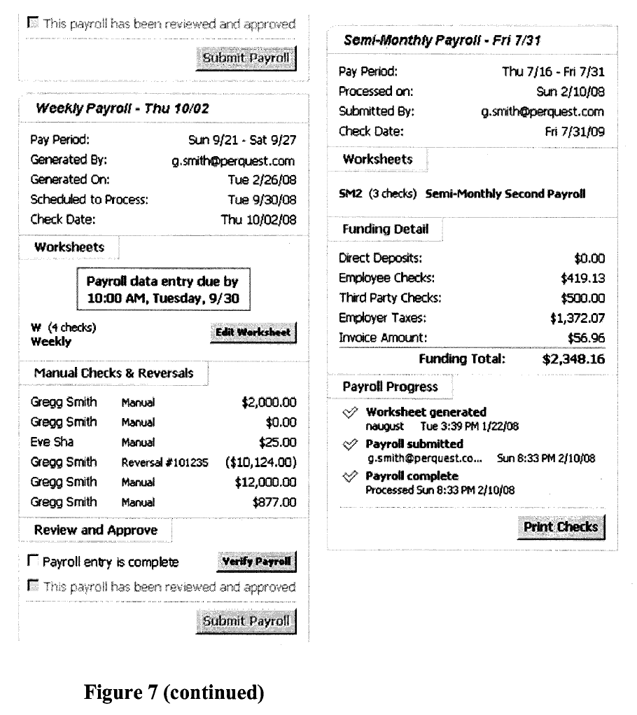

In other examples, there may be multiple panes for other time categories, such as the opened and unopened payroll data. There may be a pane for open payroll data for an employee group that is paid semi-monthly, and there may be a pane for open payroll data for an employee group that is paid weekly, as shown in FIG. 7. Similarly, there may be a pane for unopened payroll data for an employee group that is paid monthly, and there may be a pane for unopened payroll data for an employee group that is paid weekly.

In some examples, a time category may be a period of time itself, so there may be multiple panes relating to the period of time. For instance, a time category could include each month. In one implementation, if the data related to payroll data, and the time categories were for the months of September, August, and July, there may be multiple panes in any of the categories. For example, panes may be providing access to payroll data where there could be more than one employee group which may get paid under different pay periods. One employee group may get paid monthly, while another employee group may get paid weekly. In this case, there may be multiple panes for already submitted payroll data. For instance, there may be a pane for all the submitted payroll data for the last time category, which in this case would be within the last month, which may include a pane for the last submitted monthly payroll data, and there may be panes for the submitted weekly payroll data within the past month. In one example, there may be a special payroll, such as a bonus, in which case, a pane for the special payroll data may also appear as a submitted payroll data for a period of time, which in this case may be the same as the time category, which may be within the past month.

If there are multiple panes relating to a time category, a pane relating to a time category may be adjacent to another pane within the same time category. For example, in an implementation of the invention where panes relating to given time categories are oriented in a row, additional panes relating to a given time category may branch off the row. For instance, FIG. 6 shows a pane providing access to unopened payroll data on the left, then a pane providing access to open payroll data to the right of the pane relating to unopened payroll data, and a pane providing access to submitted payroll data, which in this case may be a special payroll, to the right of the opened payroll data. Directly below the pane for special payroll there may be a pane for a semi-monthly payroll, and beneath that a pane for a weekly payroll. In this case, panes for different time categories may be oriented horizontally as a row, and any additional panes relating to a given time category may be oriented vertically as a column. A column can be arranged in any way so that they can drop down from the row as shown in FIG. 6, or can be placed so that the column is above the row, or may include panes above or below the row.

In another example, the panes may be oriented so that panes for different time categories may be oriented vertically as a column, and any additional panes relating to a given time category may be oriented horizontally as a row. Similarly, any additional panes in a row may be to the right or left of the column.

In an alternate implementation, panes for different time categories may be arranged in any matter discussed previously, while any additional panes may be adjacent to other panes of the same time category.

In accordance with one aspect of the invention, each pane may provide different access rights to data. In one embodiment of the invention, different users with different rights may be able to access certain panes and may not be able to access other panes. Or users may have access rights to certain portions of a pane. For example, a payroll clerk may start a future payroll and enter payroll data, which may be approved later by a payroll professional. User access rights may be visually indicated on a pane.

In one embodiment of the invention, user access rights may remain the same for a particular pane, regardless of the time or action a pane may be referring to. For example, if time categories referred to payroll status, and panes existed for unopened payroll data, open payroll data, and submitted payroll data, user access rights may refer the same for each of the pane for a particular payroll status regardless of which payroll (i.e. a payroll for August or September) is occupying a pane.

In an alternate embodiment of the invention, user access rights may travel with a particular payroll and may not have to be fixed for a particular pane. For example, if time categories referred to payroll status, and panes existed for unopened payroll data, open payroll data, and submitted payroll data, user access rights may refer the same for each of the pane for a particular payroll (i.e. a payroll for August or September) regardless of the payroll status or pane. For instance, if there were a bonus payroll where start, entry, and approval were all done by the same payroll professional, the user access rights for the bonus payroll may remain the same, regardless of whether the bonus payroll is unopened, or has been opened or submitted.

In another aspect of the invention, there may be one or more control panes which may enable a user to perform functions relating to other parts of the user interface. Such functions may involve creating a new pane, deleting an existing pane, or modifying data accessed by a pane. In an implementation where the panes may provide access to payroll data, such functions may include starting a new payroll, adding a worksheet to an open payroll, deleting a worksheet from an open payroll, or restarting an open payroll.

In one embodiment of the invention, such panes may appear adjacent to any of the time categories it may relate to. For instance, such a control pane may exist for submitted payroll data and may appear adjacent to a pane for submitted payroll data. In one implementation, if all panes relating to a particular time category were arranged in columns, a control pane for a time category may be in the same column as other panes relating to the time category. Alternatively, such additional functions may also appear in any of the panes for a time category.

In one example, a function to start a new payroll may allow a user to create a new payroll for a given time category, where a new pane may be created relating to a given time category, and for a particular time period or data status. For instance, a time category may be for open payroll data, and a pane may exist providing access to open payroll data for an employment group that is paid semi-monthly. A user may be able to create a new payroll, which may create a new pane providing access to open payroll data for an employment group that is paid weekly.

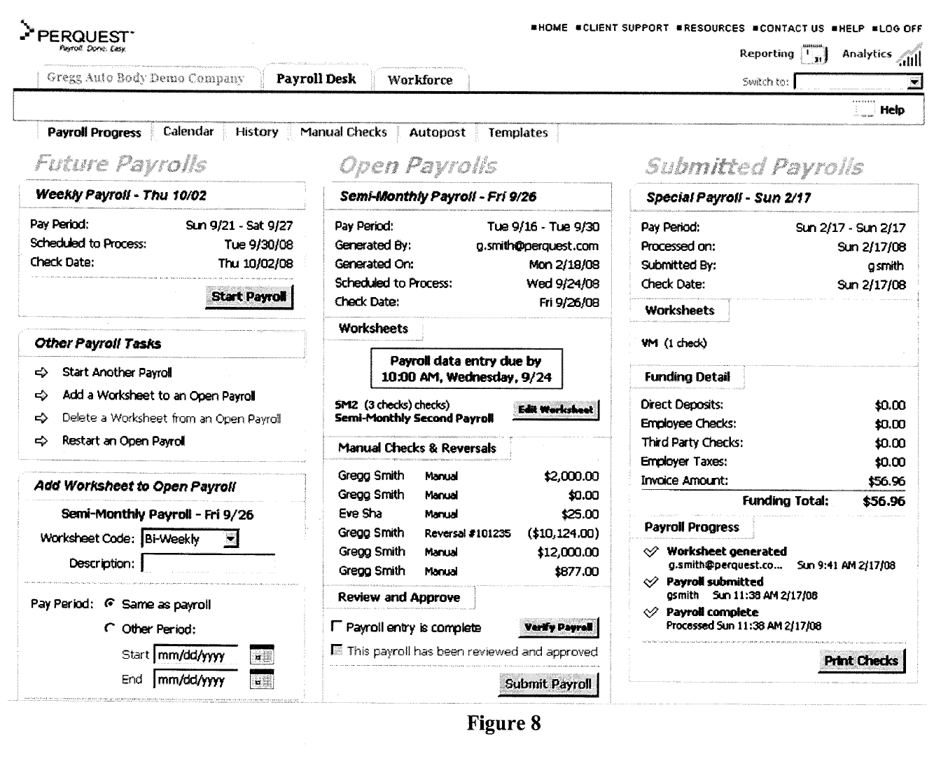

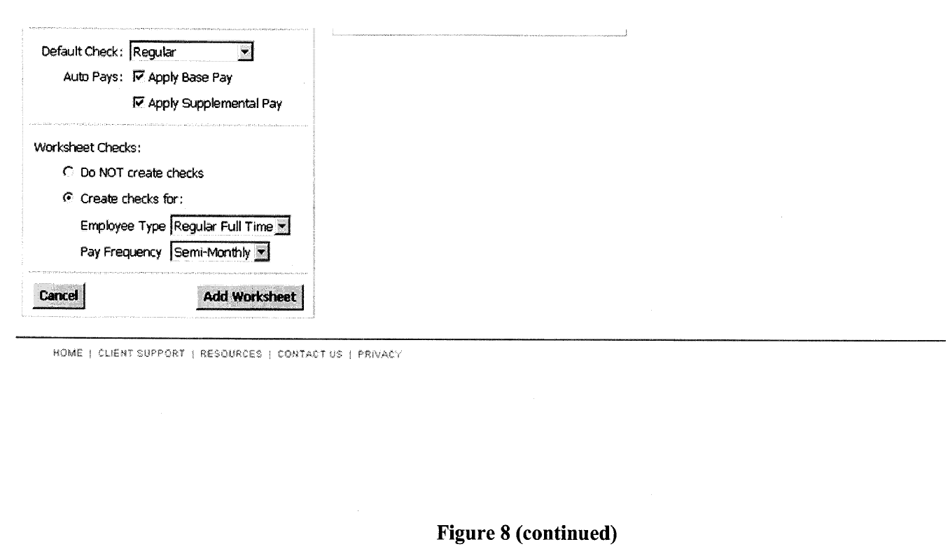

FIG. 8 illustrates an embodiment of a user interface including a pane to add a worksheet to an open payroll. The pane to add a worksheet may allow a user to create a new worksheet for a given time category, which may add a worksheet to an existing payroll. For instance, a payroll may include multiple employee groups within an existing payroll. Different worksheets may relate to different employee groups.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A user interface for accessing human capital management data comprising:
a current pane providing access to data relating to a given time category, formed with two opposing sides;
at least one completed pane, positioned adjacent to the current pane, providing access to data relating to a given time category prior to the given time category of an adjacent pane; and
at least one future pane, positioned adjacent to the current pane and opposite the completed pane, providing access to data relating to a given time category subsequent to the given time category of an adjacent pane.

2. The user interface of claim 1 further comprising a control pane enabling a user to perform functions relating to other panes of the user interface.

3. The user interface of claim 1 wherein the given time category is a pay period.

4. The user interface of claim 1 wherein the data relating to a given time category includes payroll data.

5. The user interface of claim 1 wherein the data relating to a given time category includes human capital management data.

6. The user interface of claim 1 wherein a pane providing access to data includes means for displaying some of the data, means providing a button or link to the data, means for creating a new sheet to store data, or means to perform actions with the data.

7. The user interface of claim 1 further comprising at least one additional pane providing access to data relating to a current, completed, or future time category, wherein the additional pane is adjacent to one of the following: a pane providing access to data relating to a current time category if the additional pane provides access to data relating to a current time category, a pane providing access to data relating to a completed time category if the additional pane provides access to data relating to a completed time category, or a pane providing access to data relating to a future time category if the additional pane provides access to data relating to a future time category.

8. The user interface of claim 1 wherein a pane providing access to data relating to a given time category has user access rights that remain the same if a time category passes.

9. The user interface of claim 2 wherein the control pane enabling a user to perform functions relating to other panes of the user interface relates to a time category and is located adjacent to a pane of the time category it relates to.

10. A user interface for accessing human capital management data comprising:
three or more panes, positioned adjacent to one another, wherein each pane provides access to data relating to a given time category prior to the given time category of an adjacent pane, and at least one pane provides access to data relating to a current time category.

11. The user interface of claim 10 further comprising at least one additional pane providing access to data relating to a time category wherein the additional pane is adjacent to another pane providing access to data relating to the same time category.

12. The user interface of claim 10 wherein the data relating to a given time category includes payroll data.

13. The user interface of claim 10 wherein the data relating to a given time category includes human capital management data.

14. The user interface of claim 10 wherein the given time category is a period of time.

15. The user interface of claim 10 wherein the given time category is a data status.

16. A method of implementing a user interface for accessing human capital management data comprising:
displaying three or more panes, each pane representing a discrete time category and providing access to data relating to the discrete time category, wherein each pane representing a time category is positioned adjacent to a pane representing a prior time category;
determining when a time category has passed; and
moving the access to data relating to a given time category to the position and format held by the prior time category, if a time category has passed.

17. The method of claim 16 wherein the time category is a pay period.

18. The method of claim 16 wherein the data relating to a discrete time category includes payroll data.

19. The method of claim 16 wherein the data relating to a discrete time category includes human capital management data.

20. The method of claim 16 wherein providing access to data includes displaying some of the data, providing a linking connection to the data, creating a new data storage, or performing actions with the data.

21. The method of claim 16 further comprising creating an access to data relating to a given time category immediately following the latest given time category and putting the access to data in the position and format of the latest given time category, if a time category has passed.

22. The method of claim 16 wherein each pane has specified user access rights.
